(19) United States
(12) Patent Application Publication
(10) Pub. No.: US 2013/0055222 A1
(43) Pub. Date: Feb. 28, 2013

(54) MAGNETIC RESONANCE IMAGING SYSTEM WITH PROGRAMMABLE SUBSYSTEM AND METHOD FOR PROGRAMMING

(71) Applicant: Robert David Darrow, Scotia, NY (US)

(72) Inventor: Robert David Darrow, Scotia, NY (US)

(21) Appl. No.: 13/222,908

(22) Filed: Aug. 31, 2011

(51) Int. Cl. G06F 9/45

(52) U.S. Cl. 717/140

(57) ABSTRACT

A Magnetic Resonance Imaging (MRI) system with programmable subsystem and method for programming are provided. One method includes receiving programming code having one or more Application Programming Interfaces (APIs), wherein the APIs include one or more function calls to a library of routines. The method also includes compiling the programming code with the library of routines and controlling the operation of the MRI system using the compiled programming code.

### BACKGROUND

The subject matter disclosed herein relates generally to diagnostic imaging systems, and more particularly to systems and methods for controlling the operation of Magnetic Resonance Imaging (MRI) systems.

Medical imaging systems, for example, MRI systems, are defined by a number of subsystems that interact to deliver the functionalities for these systems. The subsystems may include different physical computer systems running on different operating systems. The subsystems may be further subdivided into software applications or other logical subsystems. These software applications are typically object oriented programs that individually or in combination with other software applications perform specific functionality. For example, the functionality may include image acquisition (e.g., performing specific imaging protocols), image processing, etc.

In MRI systems, the scan subsystems for the MRI scanner are complex entities generally designed for a standard prescribe-ahead architecture. Because of the general static nature of operation, these subsystems are not designed for ease of modification. Thus, the rigid prescribe-ahead, operator-driven nature of MRI scanner workflow does not allow for ease in modification to adapt to workflow driven by algorithms and heuristics built into the scan subsystem or unique scanning requirements. In these MRI systems, each application must be separately coded, thereby resulting in even more complexity in the design and software. Also, as the complexity in software applications and the interrelationship between applications increases, the complexity in design increases even more.

### BRIEF DESCRIPTION

In accordance with various embodiments, a non-transitory computer readable storage medium for controlling operation of a Magnetic Resonance Imaging (MRI) system using a processor is provided. The computer readable storage medium includes instructions to command the processor to receive programming code having one or more Application Programming Interfaces (APIs), wherein the APIs include one or more function calls to a library of routines. The computer readable storage medium also includes instructions to command the processor to compile the programming code with the library of routines and control the operation of the MRI system using the compiled programming code.

In accordance with other embodiments, a Magnetic Resonance Imaging (MRI) system is provided that includes an imaging portion having an imaging unit configured to acquire Magnetic Resonance (MR) data. The MRI system also includes a processing portion having one or more programmable scan subsystems and a controller configured to control the programmable scan subsystems. The controller accesses one or more Application Programming Interfaces (APIs), wherein the APIs include one or more function calls to a library of routines. The processing portion includes a processor configured to compile received programming code with the library of routines and control the operation of the imaging portion with the subsystems based on the compiled programming code.

In accordance with yet other embodiments, a Magnetic Resonance Imaging (MRI) programming toolkit for workflow control and display as a graphical user interface is provided. The MRI programming toolkit includes a plurality of Application Programming Interfaces (APIs) that are calls to routines forming part of workflow control library, wherein the APIs correspond to scan control operations for an MRI scanner. The MRI programming toolkit also includes a plurality of descriptors for the plurality of APIs that are displayable as part of a graphical user interface.

### BRIEF DESCRIPTION OF THE DRAWINGS

FIG. 1 is simplified block diagram of a medical imaging system in accordance with various embodiments.

FIG. 2 is a block diagram illustrating a programmable scan control arrangement in accordance with various embodiments.

FIG. 3 is a block diagram illustrating outputs of a scan control in accordance with an embodiment.

FIG. 4 is a block diagram illustrating control of workflow using a programmable script in accordance with various embodiments.

FIG. 5 is a flowchart of a method for controlling workflow using programmable scripts in accordance with various embodiments.

FIG. 6 is a table illustrating a toolkit in accordance with an embodiment.

FIG. 7 is a schematic block diagram of a portion of a Magnetic Resonance Imaging (MRI) system in accordance with various embodiments.

FIG. 8 is a pictorial view of a portion of an MRI system in accordance with various embodiments.

FIG. 9 is a pictorial view of an MRI system in accordance with various embodiments.

FIG. 10 is a schematic block diagram illustrating the MRI system of FIG. 9.

### DETAILED DESCRIPTION

The foregoing summary, as well as the following detailed description of certain embodiments, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks may be implemented in a single piece of hardware or multiple pieces of hardware. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide a Magnetic Resonance Imaging (MRI) system with one or more programmable scan subsystems for the MRI scanner. The programmable subsystems in various embodiments are script-driven or program-driven. By one or more embodiments, at least one technical effect is simplifying scan design and implementation for an MRI system.

It should be noted that although various embodiments are described in connection with MRI systems, the various embodiments may be implemented in different types of imaging systems. For example, the various embodiments may be implemented in connection with a Computed Tomography (CT) scanner, a Positron Emission Tomography (PET) scanner, a Single-Photon Emission Computed Tomography (SPECT) scanner, an ultrasound scanner, and/or an X-ray machine, among others. The various embodiments also may be implemented in connection with multi-modality systems.

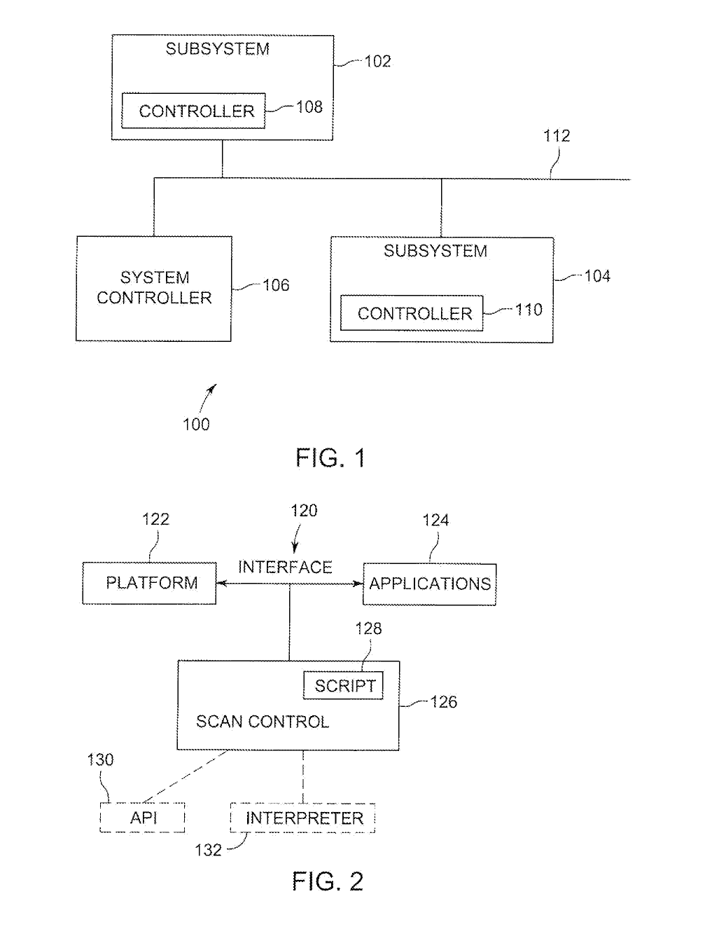

In particular, FIG. 1 shows a medical imaging system 100 that is embodied in various embodiments as an MRI system having one or more programmable subsystems. In particular, the medical imaging system 100 includes one or more physical subsystems, for example, a subsystem 102 and a subsystem 104. Further, the medical imaging system 100 also includes one or more system managers, illustrated as a system controller 106, and subsystem controllers 108 and 110 associated with each of the physical subsystems 102 and 104, respectively. A communication link 112 is also provided that allows communication between the various components.

It should be noted that although two programmable subsystems are illustrated, more or less may be provided. For example, in one embodiment, a single programmable scan subsystem is provided. In another embodiment, three or more programmable subsystems are provided.

The subsystems 102 and 104 include, for example, physical processing or operating components or entities that perform different operations in the medical imaging system 100, and in various embodiments are implemented as, but not limited to, physical computer systems running on one or more different operating systems. For example, in an MRI system, the physical subsystems may include are an MR pulse generator, a table positioner, a system control and an operator console.

The system controller 106 and the subsystem controllers 108 and 110 may be hardware, software or a combination thereof. In one embodiment, the system controller 106 and the subsystem controllers 108 and 110 are controller modules. The system controller 106, the subsystem controller 108, and the subsystem controller 110 may be, for example, software components or algorithms that interact with each other for use in performing or controlling different functions or operations (e.g., one-touch scanning) of the medical imaging system 100. Further, the functioning, components, and the properties of the subsystem controllers 108 and 110 may be the same or different as desired or needed.

The subsystem controller 108 and the subsystem controller 110 ensure that all software components in the physical subsystem 102 and the physical subsystem 104 respectively, are operating based on, for example, a particular imaging protocol. The system controller 106 communicates with the subsystem controllers 108 and 110 that are a part of the system to control the operation thereof. It should be noted that although only two subsystems 102 and 104 are shown, additional subsystems may be provided.

In various embodiments, communication between the subsystem 102, the subsystem 104, and the system controller 106 is provided via the communication link 112. The communication link 112 enables platform (e.g., operating system) independent interoperability between a plurality of physical subsystems. In various embodiments, the communication link 112 is enabled, for example, through a shared memory communication based architecture. For example, interfacing between the various embodiments may be performed using direct method calls, such as using an Interface Definition Language (IDL).

In accordance with various embodiments, a programmable scan control arrangement is provided via an interface 120 as shown in FIG. 2, which may be used to control workflow of the MRI system. The interface 120 provides for programmable interfacing between an operating platform 122 of the MRI system and applications 124 running on the MRI system. In particular, the platform 122 in various embodiments is a computing platform that includes suitable hardware architecture (for controlling operation of the MRI system) and a software framework including application frameworks including the applications 124 that can be interfaced in a programmable manner. The combination allows the software to run and control the operation of MRI system.

The platform 122 generally includes the architecture of the processors or computers of the MRI system, the operating system, the programming languages and related user interface (e.g., graphical user interface). For example, in accordance with various embodiments, a scan control 126 (e.g., a scan control module) that is script-driven or programmable is provided such that a scan performed by the MRI system may be driven with a programmable script 128 (or program). In one embodiment, a unique script or program may be provided for interfacing with each of the applications 124. For example, a programming language, such as a scripting language, script language or extension language allows control of one or more of the applications 124 and makes the compiler of the language part of the language runtime. Thus, code may be generated dynamically. The scripts 128 may be created or at least modified by an end-user and may be interpreted from source code.

In one embodiment, the scan control 126 is provided using one or more application programming interfaces (APIs) 130 that allow access to one or more libraries, in particular, scan libraries for programming the subsystems 102 or 104 (shown in FIG. 1) to perform particular scans. For example, one scan may be a prescribe-ahead scan where a user enters the scan parameters. Another scan includes, for example, a one-touch scan wherein a single button push initiates a cardiac scan or whole body scan, which may include automatic positioning of a patient. The one-touch scan allows, for example, programming of image settings for a plurality inputs into a single control. Accordingly, a plurality of operations or controls may be initiated and performed by activating a single button. The APIs 130 allow switching among multiple scans controlled by code that is in a compiled format. It should be noted that an API 130 may be created for different applications 124, libraries, operating systems, etc., to define the language and resource request conventions (e.g. function-calling conventions). For example, the API 130 may include specifications for routines, data structures, object classes, and protocols used to communicate between the subsystems 102 and/or 104 and the implementer program of the API 130 within the scan control 126.

In another embodiment, the scan control 126 is provided using one or more internal interpreters 132 that are script driven. The interpreter 132 may be any computer program that executes and performs instructions written in a programming language. For example, the interpreter 132 may be a program that executes source code directly, translates source code into an intermediate representation (code), which is then executed, or explicitly executes stored precompiled code made by a compiler, which is part of the interpreter system 132. Thus, the interpreter 132 reveals one or more interfaces 120 to perform different functionality on the system.

In various embodiments, the granularity of the functionality of the script 128 is generally at a higher level and not generated as scan code. Each step of the script 128, as described in more detail herein, encompasses one or more steps in the scan workflow, such as a load scan protocol, an auto prescan, a scan, etc. In various embodiments, new elements also may be incorporated, such as an execute algorithm, test algorithm results, an advance patient table, etc. A script-driven scan subsystem allows for the equivalent of multiple scan applications to co-exist on a single scanner, for example, a family of one-touch applications.

Using various embodiments, a new scan application 124 may be created with the script 128. In operation, such scripting permits operator-driven scanning, as well as additionally permitting algorithm-driven scanning with fully automatic operation, or a combination of both.

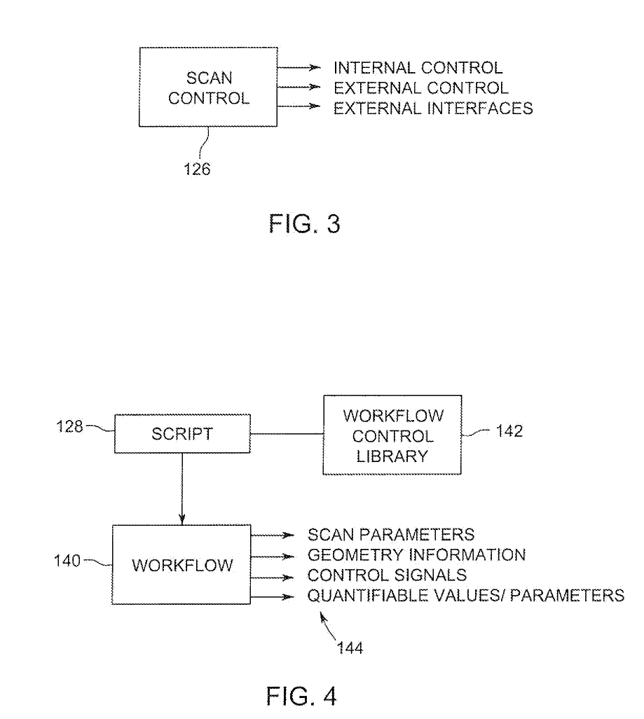

The scan control 126 can allow direct device control of the workflow. For example, as shown in FIG. 3, the scan control 126 may provide internal control of scanner resources, such as controlling a patient table or coils of the MRI system. The scan control 126 also may provide external controls, for example, control of recording/filming devices, a contrast injector or a video camera, among others. The scan control 126 also may provide external interfaces, for example, a Transistor-Transistor Logic (TTL) interface, a Universal Serial Bus (USB) interface, or a network interface (e.g., TCP/IP interface), which may be used for the link 112 (shown in FIG. 1), among others.

In various embodiments, as shown in FIG. 4, the script (program) 128 accesses a workflow control library 142 to allow control of the subsystem 102 and/or 104 (shown in FIG. 1) by the scan control 126 (shown in FIGS. 2 and 3). The scan control 126 uses the programmable script (program) 128 to control the workflow 140 of the MRI system, such that the subsystem 102 and/or 104 is controlled. As part of the workflow 140, different outputs 144 may be provided, which may be calculated within the workflow 140 using one or more algorithms. For example, scan parameters, geometry information (e.g., scan plane Rx), control signals for controlling physical devices of the MRI system and/or numerical values (e.g., quantifiable values such as cardiac ejection fraction) to be reported or displayed, among others, may be computed. The script (program) 128 may also dynamically determine the scan workflow based on the outcome of algorithmic calculations, using branching, looping and other operations. It should be noted that the workflow may be fully automated (e.g., one-touch operation), semi-automated or manual (e.g., user input driven).

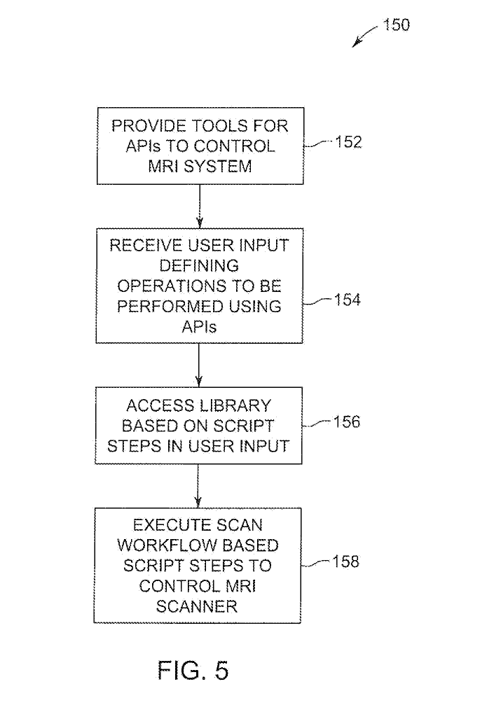

In various embodiments, a method 150 as shown in FIG. 5 is provided for controlling the workflow 140 using one or more scripts (programs) 128. In particular, the method 150 includes providing a set of tools for APIs at 152 to control the MRI system. For example, a Graphical User Interface (GUI) may be provided that includes a toolkit or toolbox that allows a user (e.g., a programmer) to access a library of routines, such as a series of function calls, namely the APIs that make calls to routines within the workflow control library 142. Thus, the APIs provide calls to object code that allows control of the MRI system using, for example, the subsystem 102 and/or 104. Thus, the APIs call routines that form part of the workflow control library 142 and that may be used to control the MRI system. The specification of the operations or functions defined by the calls also may be provided as described herein.

Thereafter, user inputs are received at 154 that define operations to be performed using the APIs. For example, one or more user inputs may be embodied as programming code that is written in any suitable programming language, for example, based on the interface requirements of the MRI system. The programming code may be, for example, binary code, Java code, HTML code and/or C++ code, among others.

The user input at 154, which in the illustrated embodiment is programming code having APIs embedded therein, is then compiled to access at 156 the workflow control library 142 based on the script steps in the programming code. For example, the programming code may be compiled at runtime such that the APIs are compiled with the workflow control library 142 and accessed dynamically when the particular operation corresponding to the programming code (e.g., one-touch cardiac scan code) is initiated, such as by an operator of the MRI system selecting the particular function. The compiling also may be static wherein the APIs and library calls are embedded within the programming code.

Thus, the programming code with the APIs interact with the workflow control library 142 having a library of workflow control routines to control the MRI system, which may include controlling one or more subsystems. Accordingly, a scan workflow is executed at 158 based on the script steps in the programming code to control the MRI scanner. The script steps may correspond to one or more steps in the scan workflow, for example, based on the series of functions calls that access the workflow control library 142.

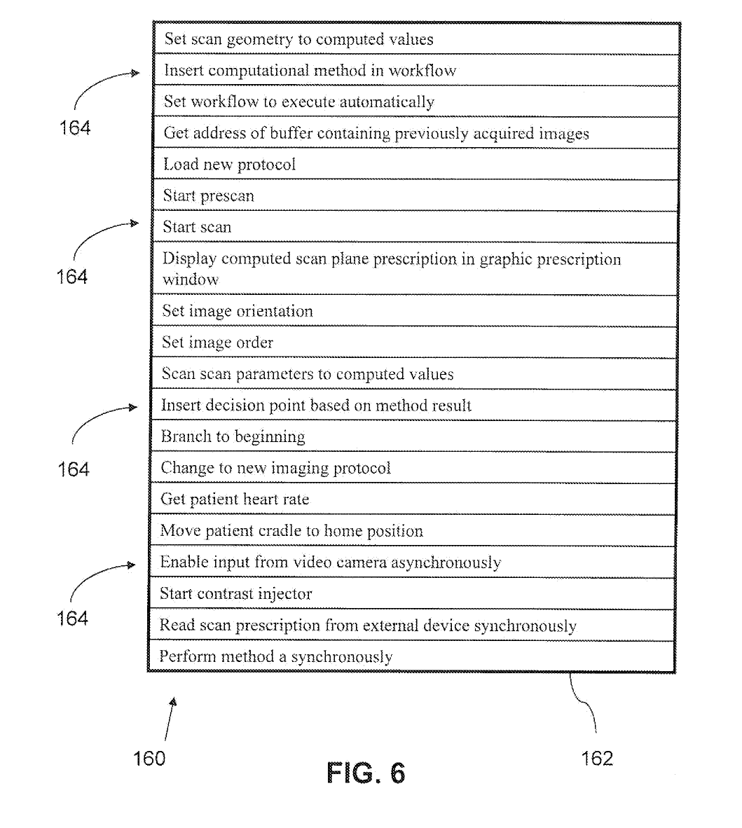

A toolkit 160 as shown in FIG. 6 may be provided that includes a library 162 of routines 164 for controlling the MRI scanner, which correspond to all or a subset of the routines in the workflow control library 142. The toolkit 160 may, for example, form part of a programming application, such as a software programming application for the MRI system, and which may be installed in one or more modules of the various embodiments and displayed as a User Interface (UI). Each row of the table corresponds to different workflow routines 164 that are accessible in one embodiment and that correspond to one or more features of operations available as part of the toolkit 160. The illustrated description of the routines 164 is defined by high-level architectural aspects in accordance with one embodiment. It should be noted that the library 162 and the illustrated routines 164 are merely for illustration. Thus, any type or kind of command or routine may be provided in accordance with various embodiments, which is not limited to controlling an MRI scanner.

It should be noted that each of the routines 164 may correspond to one or more different types of scans that may be performed by the MRI system. For example, the routines 164 may correspond to different one-touch applications, such as one-touch cardiac, neurological, knee, spine or whole body scans, among others. In this embodiment, the operator may utilize a one-touch button on a user interface to initiate a scan protocol, such that a one-touch display may include buttons, for example, virtual buttons, that designate a type of scan or scan protocol. By selecting a single button, the scan is started based on the designated type of scan or scan protocol and using the programming code corresponding to the selection.

Thus, a programmable scan subsystem for an MRI scanner may be provided such that a scan is driven with a programmable script or program. For example, the pseudo-code below illustrates a fully automatic one touch cardiac script that may be coded using one or more embodiments. The one touch cardiac script controls the MRI system using one or more of the subsystems 102 and 104 (shown in FIG. 1) to acquire localizer images, perform algorithmic computation to compute cardiac planes, and acquire cardiac images. The exemplary pseudo-code is as follows:

start:

run scanner localizer protocol
do short-axis, 4-chamber & 2-chamber calculation

sa:

display computed short-axis slices in graphic prescription window
do short-axis acquisition

4ch:

display computed 4-chamber slices in graphic prescription window
do 4-chamber acquisition

2ch:

display computed 2-chamber slices in graphic prescription window
do 2-chamber acquisition

end:

Accordingly, a computational-driven scanning model may be provided that is programmable using a script or program that accesses libraries of calls for controlling the MRI scanner. In various embodiments, the programming that may define new applications are platform independent, thus ensuring the entire platform does not require verification and validation prior to releasing a new application.

The various embodiments also may provide other programmable workflow operations, for example, automated scan plane Rx that is not operator driver, automated protocol selection that is not radiologist driven, automated landmarking that is not operator driven, automated control of scanner devices that does not require user inputs and/or automated observation and response of patient motion that does not require user observation, among others.

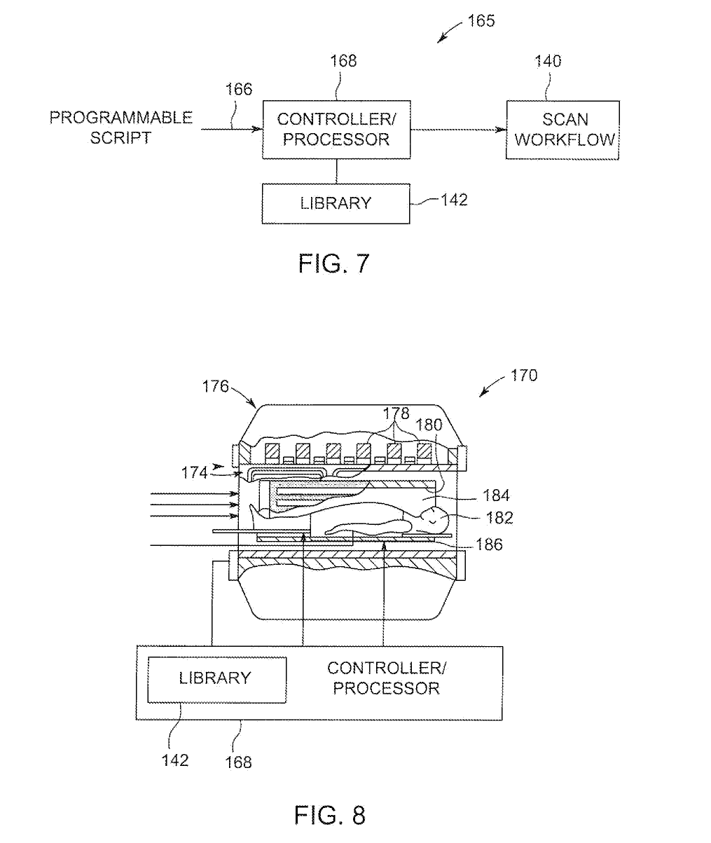

Thus, as illustrated in FIG. 7, a programmable scan subsystem 165 may be provided wherein a programmable script input 166 (e.g., the script 128 shown in FIG. 4) may be used by a controller/processor 168 to access the workflow control library 142 (having a plurality of routines) to drive the scan workflow 140 of the MRI system. It should be noted that the library may be provided as part of the MRI system or separately therefrom.

As shown in FIG. 8, the controller/processor 168 may form part of an MRI system 170, for example, may be embodied as the system controller 106 or the subsystem controller 108 or 110. The controller/processor 168 may control operations or generate other MRI signals for controlling the MRI system 170. The controller/processor 168 may be any type of processing unit, for example, a CPU, and may include the workflow control library 142 to access routines to control the MRI system 170 in accordance with various embodiments.

In the MRI system 170, a gradient coil assembly 174 forms part of a magnet assembly 176 that includes a polarizing magnet 178 and a whole-body RF coil 180. A patient 182 may be positioned within a cylindrical patient imaging volume 184 of the magnet assembly 176. The controller/processor 168 may be driven by the programmable scan subsystem 165 to, for example, move a table 186 on which the patient 182 is positioned or produce pulses that may be amplified by an RF amplifier (not shown) and to drive the RF coil 180 for a specific scan protocol. The resulting signals emitted by the excited nuclei in the patient 182 may be sensed by the same RF coil 180 and preamplified. The amplified MR signals are demodulated, filtered and digitized in the receiver section of the transceiver and may be used to form MR images using any suitable image reconstruction method.

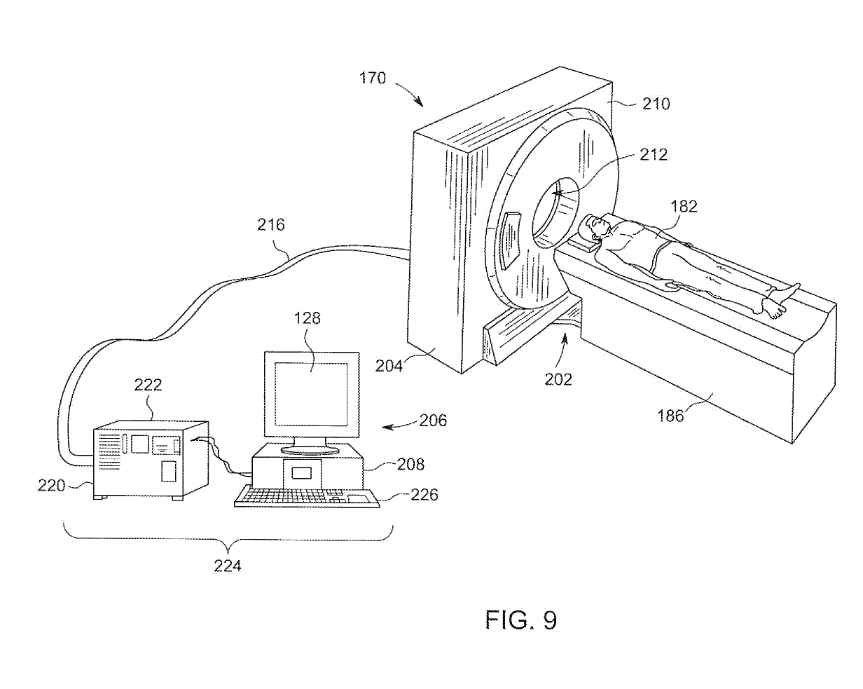

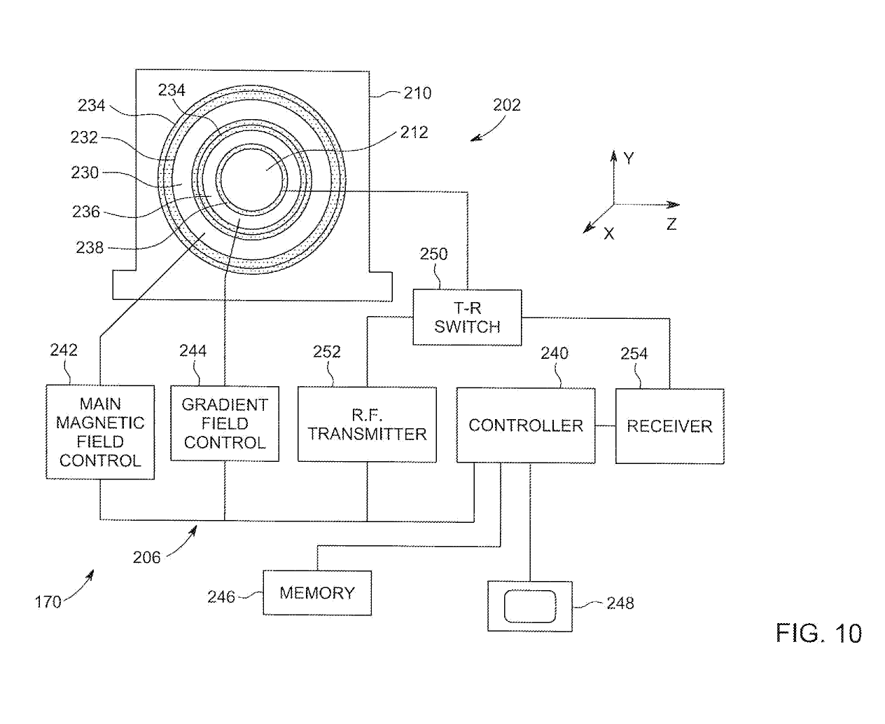

The MRI system 170 may be embodied as illustrated in FIGS. 9 and 10. The MRI system 170 includes an imaging portion 202 having an imaging unit 204 (e.g., imaging scanner) and a processing portion 206 that may include a processor 208 or other computing or controller device, which includes the controller/processor 168 (shown in FIGS. 7 and 8). In particular, the imaging unit 204 enables the MRI system 170 to scan the patient 182 to acquire image data, which may be image data of all or a portion of the object or patient 182. The imaging unit 204 includes a gantry 210 that includes one or more imaging components (e.g., magnets or magnet windings within the gantry 210) that allow acquisition of the image data. In multi-modality imaging systems, in addition to the magnet(s) for MRI, an X-ray source and detector for CT imaging, or gamma cameras for Nuclear Medicine (NM) imaging may be provided. The imaging components produce signals that represent image data that is communicated to the processing portion 206 via a communication link 216 that may be wired or wireless. It should be noted that the signals may be configured in different protocols, etc. It should also be noted that during an imaging scan by the imaging unit 204, the gantry 210 and the imaging components mounted thereon or therein may remain stationary or rotate about or along a center of rotation defining an examination axis through a bore 212. The patient 182 may be positioned within the gantry 210 using, for example, the motorized table 186.

Thus, in operation an output of one or more of the imaging components is transmitted to the processing portion 206, and vice versa, which for example, may include, transmitting signals to or from the processor 208 through a control interface 220. The processor 208 also may generate control signals for controlling the position of the motorized table 186 or imaging components based on, for example, user inputs or a predetermined scan. The signals may be generated by a programmable script or subsystem as described herein. During a scan, image data, such as magnetic resonance image data from the imaging components may be communicated to the processor 208 through a data interface 222 via the control interface 220. The processor 208 and associated hardware and software used to acquire and process data may be collectively referred to as a workstation 224. The workstation 224 includes user input devices, such as a keyboard 226 and/or other input devices such as a mouse, a pointer, and the like, and a monitor 228. The monitor 228 displays image data and may accept input from a user if a touchscreen is available.

For illustrative purposes only, the MRI system 170 may be implemented as shown in FIG. 10, which generally includes the imaging portion 202 and the processing portion 206 that may include a processor or other computing or controller device as described herein. The MRI system 170 generally includes within the gantry 210 a superconducting magnet 230 formed from coils, which may be supported on a magnet coil support structure. A helium vessel 232 (also referred to as a cryostat) surrounds the superconducting magnet 230 and may be filled with liquid helium. The liquid helium may be used to cool a coldhead sleeve and/or a thermal shield.

Thermal insulation 234 is provided surrounding the outer surface of the helium vessel 232 and the inner surface of the superconducting magnet 230. A plurality of magnetic gradient coils 236 are provided inside the superconducting magnet 230 and an RF transmit coil 238 is provided within the plurality of magnetic gradient coils 236.

In some embodiments, the RF transmit coil 238 may be replaced with a transmit and receive coil. The components within the gantry 210 generally form the imaging portion 202. It should be noted that although the superconducting magnet 230 is a cylindrical shape, other shapes of magnets can be used.

The processing portion 206 generally includes a controller 240, a main magnetic field control 242, a gradient field control 244, a memory 246, a display device 248, a transmit-receive (T-R) switch 250, an RF transmitter 252 and a receiver 254.

In operation, a body of an object, such as the patient 182 (shown in FIGS. 8 and 9) or a phantom to be imaged, is placed in the bore 212 on a suitable support, for example, a patient table, such as the table 186 (shown in FIGS. 8 and 9). The superconducting magnet 230 produces a uniform and static main magnetic field Bo across the bore 212. The strength of the electromagnetic field in the bore 212 and correspondingly in the patient 182, is controlled by the controller 240 via the main magnetic field control 242, which also controls a supply of energizing current to the superconducting magnet 230.

The magnetic gradient coils 236, which include one or more gradient coil elements, are provided so that a magnetic gradient can be imposed on the magnetic field Bo in the bore 212 within the superconducting magnet 230 in any one or more of three orthogonal directions x, y, and z. The magnetic gradient coils 236 are energized by the gradient field control 244 and are also controlled by the controller 240.

The RF transmit coil 238, which may include a plurality of coils, is arranged to transmit magnetic pulses (designed according to one or more embodiments) and/or optionally simultaneously detect MR signals from the patient 182 if receive coil elements are also provided, such as a surface coil configured as an RF receive coil. The RF receive coil may be of any type or configuration, for example, a separate receive surface coil. The receive surface coil may be an array of RF coils provided within the RF transmit coil 238.

The RF transmit coil 238 and the receive surface coil are selectably interconnected to one of the RF transmitter 252 or receiver 254, respectively, by the T-R switch 250. The RF transmitter 252 and T-R switch 250 are controlled by the controller 240 such that RF field pulses or signals are generated by the RF transmitter 252 and selectively applied to the patient 182 for excitation of magnetic resonance in the patient 182. While the RF excitation pulses are being applied to the patient 182, the T-R switch 250 is also actuated to disconnect the receive surface coil from the receiver 254.

Following application of the RF pulses, the T-R switch 250 is again actuated to disconnect the RF transmit coil 238 from the RF transmitter 252 and to connect the receive surface coil to the receiver 254. The receive surface coil operates to detect or sense the MR signals resulting from the excited nuclei in the patient and communicates the MR signals to the receiver 254. These detected MR signals are in turn communicated to the controller 240. The controller 240 includes a processor (e.g., image reconstruction processor), for example, that controls the processing of the MR signals to produce signals representative of an image of the patient 182.

The processed signals representative of the image are also transmitted to the display device 248 to provide a visual display of the image. Specifically, the MR signals fill or form a k-space that is Fourier transformed to obtain a viewable image. The processed signals representative of the image are then transmitted to the display device 148.

The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, Reduced Instruction Set Computers (RISC), Application Specific Integrated Circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A non-transitory computer readable storage medium for controlling operation of a Magnetic Resonance Imaging (MRI) system using a processor, the computer readable storage medium including instructions to command the processor to:
receive programming code having one or more Application Programming Interfaces (APIs), the APIs including one or more function calls to a library of routines;
compile the programming code with the library of routines; and
control the operation of the MRI system using the compiled programming code.

2. The non-transitory computer readable storage medium of claim 1, wherein the library of routines is stored within a subsystem of the MRI system and the instructions command the processor to dynamically compile the programming code with the stored library of routines at a runtime.

3. The non-transitory computer readable storage medium of claim 1, wherein the library of routines is embedded within the programming code and the instructions command the processor to compile the programming code with the embedded library of routines.

4. The non-transitory computer readable storage medium of claim 1, wherein the instructions command the processor to interface with an application based on the compiled programming code to control the operation of the MRI system.

5. The non-transitory computer readable storage medium of claim 4, wherein the application comprises one or more one-touch applications.

6. The non-transitory computer readable storage medium of claim 1, wherein the programming code comprises one or more programmable scripts that correspond to one or more steps of a scan workflow of the MRI system.

7. The non-transitory computer readable storage medium of claim 6, wherein the programmable scripts are defined by the APIs based on a programming toolkit.

8. The non-transitory computer readable storage medium of claim 1, wherein the instructions command the processor to perform a scan control to control the operation of the MRI system using an internal interpreter.

9. The non-transitory computer readable storage medium of claim 1, wherein the compiled programming code defines an application for controlling operation of the MRI system.

10. The non-transitory computer readable storage medium of claim 1, wherein the instructions command the processor to perform programmable workflow operations based on the compiled programming code, the programmable workflow operations including at least one of an automated scan plane Rx that is not operator driver, an automated protocol selection that is not radiologist driven, an automated landmarking that is not operator driven, an automated control of scanner devices without user inputs or an automated observation and response of patient motion without user observation.

11. A Magnetic Resonance Imaging (MRI) system comprising:
an imaging portion having an imaging unit configured to acquire Magnetic Resonance (MR) data; and
a processing portion having one or more programmable scan subsystems and a controller configured to control the programmable scan subsystems, the controller accessing one or more Application Programming Interfaces (APIs), the APIs including one or more function calls to a library of routines, the processing portion having a processor configured to compile received programming code with the library of routines and control the operation of the imaging portion with the subsystems based on the compiled programming code.

12. The MRI system of claim 11, wherein the library of routines is stored within one of the subsystems and the processing portion is further configured to dynamically compile the programming code with the stored library of routines at a runtime.

13. The MRI system of claim 11, wherein the library of routines is embedded within the programming code and the processing portion is further configured to compile the programming code with the embedded library of routines.

14. The MRI system of claim 11, wherein the processing portion is further configured to interface with an application based on the compiled programming code to control the operation of the imaging portion.

15. The MRI system of claim 14, wherein the application comprises one or more one-touch applications.

16. The MRI system of claim 11, wherein the programming code comprises one or more programmable scripts that correspond to one or more steps of a scan workflow of the imaging portion.

17. The MRI system of claim 16, wherein the programmable scripts are defined by the APIs based on a programming toolkit.

18. The MRI system of claim 11, wherein the processing portion is further configured to perform a scan control to control the imaging portion using one of an internal interpreter or a compiled program.

19. A Magnetic Resonance Imaging (MRI) programming toolkit for workflow control and display as a graphical user interface, the MRI programming toolkit comprising:
a plurality of Application Programming Interfaces (APIs) that are calls to routines forming part of workflow control library, the APIs corresponding to scan control operations for an MRI scanner; and
a plurality of descriptors for the plurality of APIs that are displayable as part of a graphical user interface.

20. The MRI programming toolkit of claim 19, wherein the workflow control library is stored within one or more subsystems of the MRI system.
